(19) United States
(12) Patent Application Publication
(10) Pub. No.: US 2004/0109094 A1
(43) Pub. Date: Jun. 10, 2004

(54) Visual/audio system for advertising

(76) Inventors: Brian Lindsay, Capetown (ZA); Duncan Lindsay, Johannesburg (ZA)

Correspondence Address: EDWARD D. GILHOOLY, 28 E. JACKSON BLVD., SUITE 423, CHICAGO, IL, 60604, US

(21) Appl. No.: 10/612,708

(22) Filed: Jul. 2, 2003

Related U.S. Application Data
(60) Provisional application No. 60/392,797, filed on Jul. 2, 2002.

(51) Int. Cl. H04N 5/66

(52) U.S. Cl. 348/739; 348/801

(57) ABSTRACT

A video/audio system for delivering video and audio information, such as news and advertisements, and entertainment to patrons and customers of a petroleum station having a LED visual display and adjacent audio speakers. The LED video display is controlled by a light sensor to vary the brightness of the screen on existing light conditions, such as at night, at bright sunlight conditions, and critical conditions between night and bright sunlight. An audio microphone detects ambient sound levels at the site to control an amplifier and maintain audio output at a predetermined level above ambient noise. The LED screen is optimally arranged to seen by a majority of the customers at the gasoline pumps.

This application claims benefit of our provisional application Serial No. 60/392,797 filed Jul. 2, 2002.

### BACKGROUND OF THE INVENTION

1. Field of the Invention

This invention relates in general to electronic visual display systems and, in particular, to an outdoor electronic visual and audio display showing advertising, news, entertainment, and other information capable of being viewed and heard by a group of individuals at multiple positions.

2. Summary of the Prior Art

Advertising and the conveyance of other information has long been displayed on signs and in the recent years more frequently on outdoor electronic display screens. Advertisers constantly seek to expand their ability of conveying information to sell products to the widest group of consumer active individuals. For these reasons, advertisers are constantly striving to explore new media to display its messages to the public.

A potentially underutilized locale for advertising exists where the public is present in a considerable numbers by vehicle or foot traffic, such as at gasoline station. Gas stations commonly advertise products on signs at convenience stores for their own products or have limited visual screens at individual gasoline pumps. These known techniques have been ineffective in attracting the attention of the purchaser and have not attained optimum economic results. It is desirable to have a large display of advertising information, in conjunction with entertainment and news, particularly for products at the convenience store of the station, conveyed in a manner to attract viewing by all of the customers at a gasoline station while the individuals, including non-purchasers, must wait while gasoline is dispensed. Attempts in the past to provide such advertising systems at gasoline stations have proven ineffective and uneconomical. Several problems are encountered at gasoline stations, to effectively use an electronic display system for advertising. It is highly advantageous from economic and service considerations, as well to better attract the attention of the consumer, to use a single, large, impact screen where possible, instead of smaller multiple screen throughout the gasoline station, as in prior techniques. Light conditions at a station site also provide considerable difficulties in the efficient display of screen images. The display device must be capable of being clearly seen during critical bright sunlight periods, other daylight conditions, and at night. None of the prior art displays have been sufficiently bright or effective in overcoming the problems associated with varying ambient light conditions occurring day and night at a gasoline station. In addition, the audio portion of audio-visual electronic advertising has been very inefficient in conveying advertising messages. The effective transmission of sound at an outdoor site is particularly difficult, because surrounding ambient sound conditions, such as arising from traffic, emergency equipment, wind velocity, and the like, are constantly changing. The prior art techniques of advertising at outdoor sites have not been efficient to insure that the individual is attracted to clearly see and hear the message being displayed on an electronic screen.

Known systems displaying images adjacent vehicles suffering from the foregoing defects are disclosed in U.S. Pat. No. 4,073,368 entitled AUTOMATED MERCHANDISING SYSTEM issued Feb. 14, 1978 to Mustapick; U.S. Pat. No. 5,907,275 entitled ORDER COMMUNICATION SYSTEM issued Jan. 30, 1998 to Battistini et al., and U.S. Pat. No. 4,264,923 entitled AUTO TELEVISION THEATER issued Apr. 28, 1981 to Reich. Besides the importance of the consumer seeing and hearing the advertising and the like on the screen, improvement are needed in the prior art for transmitting digital material to remote sites. For these reasons, it is desirable in the prior to provide visual display system that can effectively and economically provide advertising images and audio at remote locations, such as gasoline stations, from a central transmitting system.

### SUMMARY OF THE INVENTION

It is, therefore, an objective of this invention to provide an improved visual and audio display system for advertising and attention diverting entertainment and news at outdoor and indoor locales, such as at gas stations. The system herein disclosed employs a large screen outdoor audio/visual presentation to the environment of a gasoline station and adjoining convenience store, if present. The display screen is uniquely positioned to be viewed by potential consumers located within a 180° horizontal angle relative to the face of the video screen. The video screen possesses unique visual and operative characteristics designed specifically for gas station environments. The video/audio presentation is digitally transmitted to multiple remote locations at which the display screen is located. In one mode of the invention, the system is run with a repeating loop of advertising, news, and entertainment, the duration of which is correlated with average dwell time of the gasoline station and convenience store customers.

In the invention herein disclosed, the material is transmitted at “broadcast quality” via satellite to a band disk antenna at the multiple gas station and convenience store sites for processing by a PC device. After processing the presentation is displayed on a large LED screen. Although not intended to be so limited, the large screen has a physical resolution of at least 10,000 pixels which is enhanced electronically to many times the physical resolution. The brightness of the screen is uniquely designed to possess defined brightness levels respectively, for normal daylight, critical daylight and nighttime. In addition, the presentation may also be displayed on standard television monitors located in the convenience store or other locales. Audio delivery systems are equipped on the areas of the gasoline station adjacent the gasoline pumps and the convenience store. The ambient noise levels at the site are monitored at regular intervals through microphones to accordingly adjust the audio delivery system. The visual display unit of the invention is arranged to be located at the optical position for the eye line of customer taking into account any interfering physical objects present at the site. In addition, the system herein disclosed is capable of audio diagnostics and return path for the expeditious correction of any errors in transmission and playout.

### BRIEF DESCRIPTION OF DRAWINGS

FIG. 1 is top plan view of a gasoline station site employing the visual/audio system of the invention;

FIG. 2 is schematic view of the multicasting system for the visual/audio system of the invention,

FIG. 3 is a perspective front elevational view of the visual/audio system of the invention;

FIG. 4 is a top plan of second modified gasoline station site employing the visual/audio system of the invention,

FIG. 5 is a top plan of third modified gasoline station site employing the visual/audio system of the invention;

FIG. 6 is a top plan of fourth modified gasoline station site employing the visual/audio system of the invention;

FIG. 7 is a top plan of fifth modified gasoline station site employing the visual/audio system of the invention;

FIG. 8 is a top plan of sixth modified gasoline station site employing the visual/audio system of the invention; and

FIG. 9 is a top plan of seventh modified gasoline station site employing the visual/audio system of the invention.

### DESCRIPTION OF THE PREFERRED EMBODIMENTS

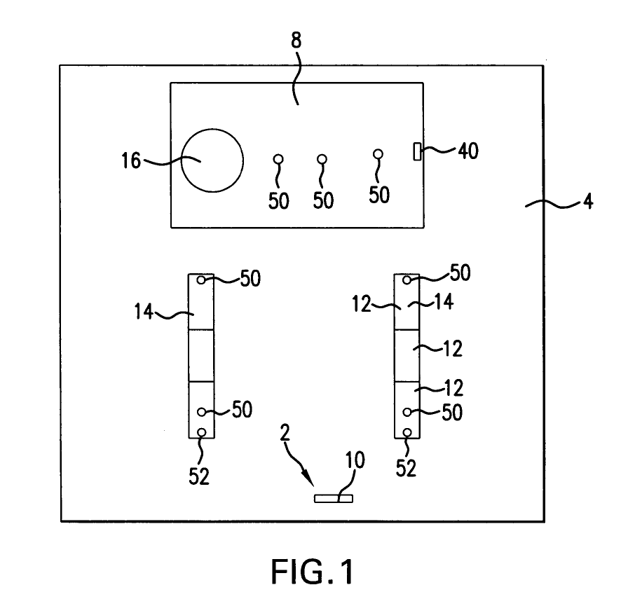

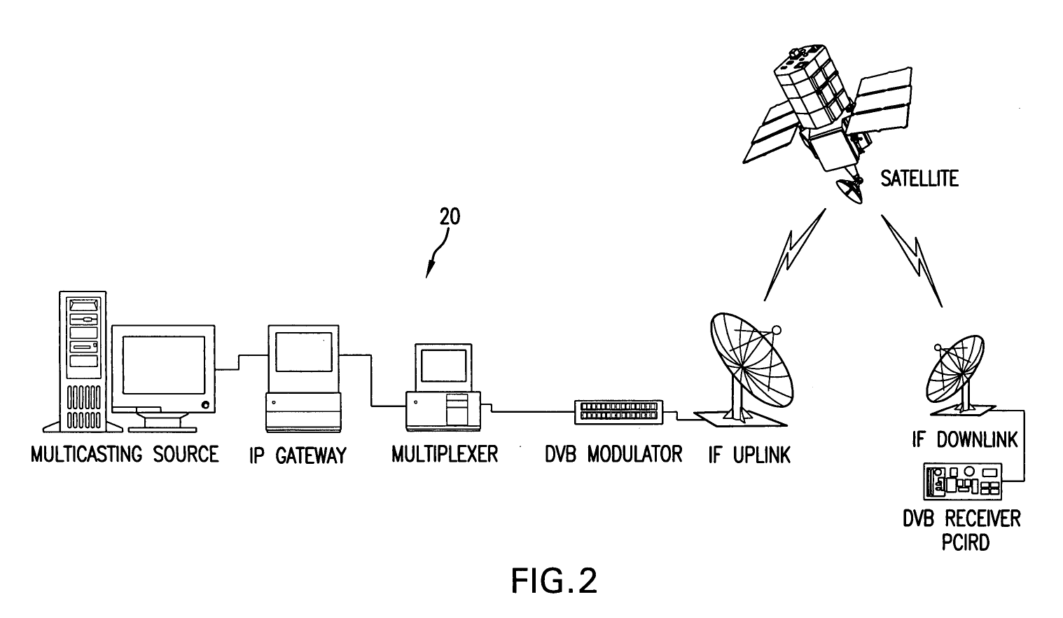

Referring to the drawings there is illustrated the video/audio system of the invention, generally designated by reference numeral 2. The video/audio system 2 will be described with reference to the geographical site configuration of the gasoline station site 4 having a convenience store 8 as shown in FIG. 1. It is within the scope of the invention to use the video/audio system 2 with a wide range of other site configurations as will be described later. Further, even though the visual/audio system 2 is described for use in the environment of a gasoline station site and convenience store, the system 2 is equally adaptable for use at malls and other locales at which consumers are present on foot or by vehicle. Referring to FIGS. 1 and 2 in the illustrated geographical configuration, system 2 includes a video screen 10 preferably in the form of LED electronic display being mounted on a stand (not shown) at height dependent on conditions. The screen 10 is positioned on the site 6 of the gasoline station site 4 having multiple gas pumps 14, typically mounted on islands or individually. The convenience store 8 conventionally sells food and merchandise to the customers purchasing gasoline and the like along with their passengers and to the consumers in general not buying petroleum products. The screen 10 displays a presentation of advertising, news and/or entertainment, the latter two materials being intended to attract potential consumers to the advertising messages at the site. The video screen 10 receives a visual signal via fiber optic circuitry (not shown) from a dish antenna 16 suitably mounted on the convenience store 8 or other structure on the gasoline station site 4.

The screen 10 displays a presentation of advertising, news and/or entertainment, the latter two materials being intended to attract potential consumers to the advertising messages at the site. The video screen 10 receives a visual signal via fiber optics circuiting (not shown) from a dish antenna 12 suitably mounted on the convenience store or other structure on the gasoline station site 4.

Referring to the FIG. 2, there is illustrated the transmission system 20 by which the presentation on video screen 10 is transmitted. The video/audio material is transmitted from multicasting source 22 by a terrestrial dedicated line to the Divicast IP head-end which is located at Obricom. The material is then processed through an IP multicasting infrastructure 24 and transmitted by satellite 26 to the remote sites, such as at gasoline stations.

The process consists of connecting a IP Gateway 26 to convert LAN packets in DVB packets. A multiplex 28 inserts multicasting sources into a single stream and a DVB modulator 30 takes a DVB formatted stream and adds forward error correction coding needed to ensure that the signal is transmitted and received clearly. An IF Uplink 30 transmits the signal to the satellite transponder 32 which transmits a signal to the site 4. An IF Downlink 32 amplifies and converts the received satellite signal into a low frequency signal for the receiver. The receiver 34 converts and locks to the satellite carrier signal back into IP protocol for the remote sites. The signal being transmitted by the foregoing satellite system is received in broadcast quality material content, usually in broadcast quality Betacam format.

The processes carried out for the broadcast quality signal includes quality assurance of the received material. This comprises verification that the material is “broadcast quality” in terms of both the visual and audio components by standard components. Corrections to the incoming material with respect to the audio component are made to equalize the sound pressure profile of all content to a common standard. This is necessary because advertisements are typically produced at different audio compression levels in order to create audio impact. When mixed with other content the impression given is that the audio is louder than, for example, entertainment content. This process is achieved by means of an “Optimod” unit or suitable audio unit (not shown). A printout of the final audio profile for the whole loop is then produced to verify compliance within the specified limits. The content is then encoded in Mpeg 1 format at 2.5 Mbits/second. Gamma correction is applied to the visual component of the material in the DS edit suite. This is necessary because the play-out LED screen 10 on the site 4 has a different gamma profile to other optical devices and to the human eye. Typically, the content is corrected to a gamma of 2.2, which is compatible with an LED Display System. The content is then programmed through a playlist (not shown) using Eclipse multi-data courier software, such as an Eclipse MDC Composer and Sprinter. The transmitted signal from the satellite is received by dish 12, which may be, for example, a Ku Band Dish Antenna 16 and a LNB. The LNB is a Vecom Universal dual pole single output unit or other suitable available equipment. A conventional PC is connected to the output signal. The PC may be, for example, an industrial PC unit fitted with an Mpeg decoder card; a Broadlogic 2030 PCIRD satellite receiver card and a purpose designed motherboard, although other data processors may be used. The video/audio connections between the data device and the playout screens are AV. The video connection is by fiber optic cable, as previously described.

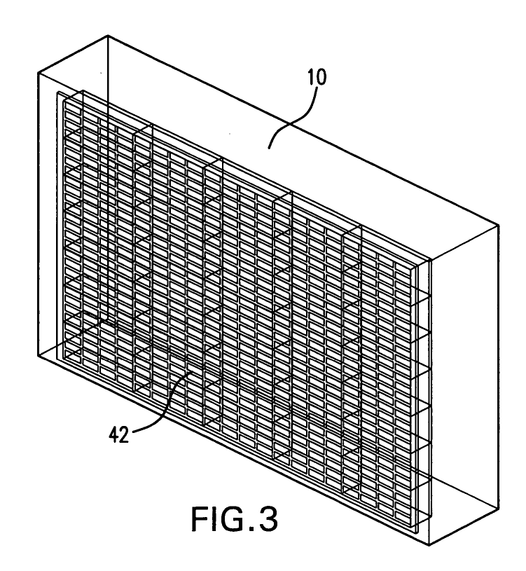

There are two visual displays at site 4 shown in FIG. 1, including the video screen 10 and a monitor 40 suitably mounted in the convenience store 8. As seen in FIG. 3, the video screen 10 employs a small pixel pitch 42 as small as possible so that LED picture does not look grainy. It is also important that the video picture on the video screen 10 have a sufficiently large resolution. This is accomplished by having more than 14,000 pixels, with 14,976 being found highly suitable, which can be enhanced to over 85,000 pixels electronically in a conventional manner. The screen 10 can possess a size of 15 mm pitch and 11 mm physical pitch depending on conditions.

The physical size of the LED display depends upon the pixel pitch and the resolution (total number of physical pixels). It is essential that these requirements be balanced with right sizing of the display unit for the environment in which it is to be used. There are well-established criteria for determining the minimum viewing distance; the optimum viewing distance and the maximum viewing distance. These need to be balanced so the that the display unit does not appear too small (with reduced impact) or too large (and overpowering) in the environment.

The combination of pixel and physical resolution of video screen 10 has been found to be optimum in physical sizes of 2160×1560 mm (15 mm pitch) and 1620×1170 mm (11 mm pitch) which gives optimum viewing distances of 12.80 and 9.50 meters respectively maximum distances of 25.50 and 19.00 meters respectively. In using the video screen 10, the screens has a horizontal viewing angle of 120 degrees and vertical viewing angle of 40 degrees. This parameter is fixed at the angle at which the brightness of 50% of the brightness normal to the screen. In practice the horizontal angle which give acceptable viewing is 180 degrees. The vertical angle is a less important criterion as it is a determinant of the height of mounting of the display unit, which once decided is fixed.

It is normally accepted that an outdoor LED screen 10 should have a quoted brightness of a minimum of 5000 NITS to be able to perform adequately in full sunlight. The video screen 10 is specified in this way and the normal standard of 5000 NITS. The brightness of a screen 10 can be computed from the aggregate sum of the brightness of the individual diodes at a give electrical current. Each pixel consists of one red; one blue and one green diode. Each type of diode has a manufacturer quoted maximum current of 20 mA current as an industry standard. The brightness achieved is directly proportional to the electrical current put through it. Diode life is typically specified as 100000 hours. Typically there can be up to a 30% reduction in theoretical brightness dependent on the actual operating current that is without severely reducing their life.

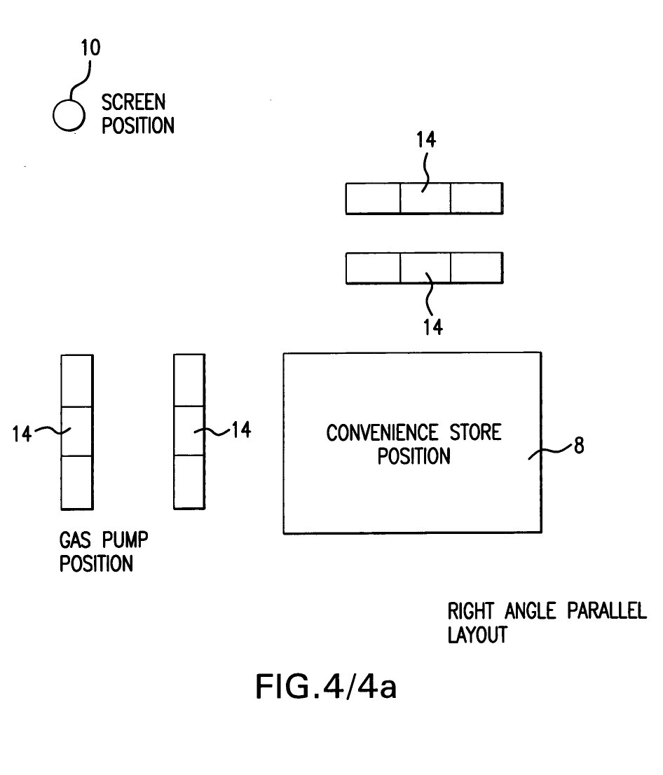

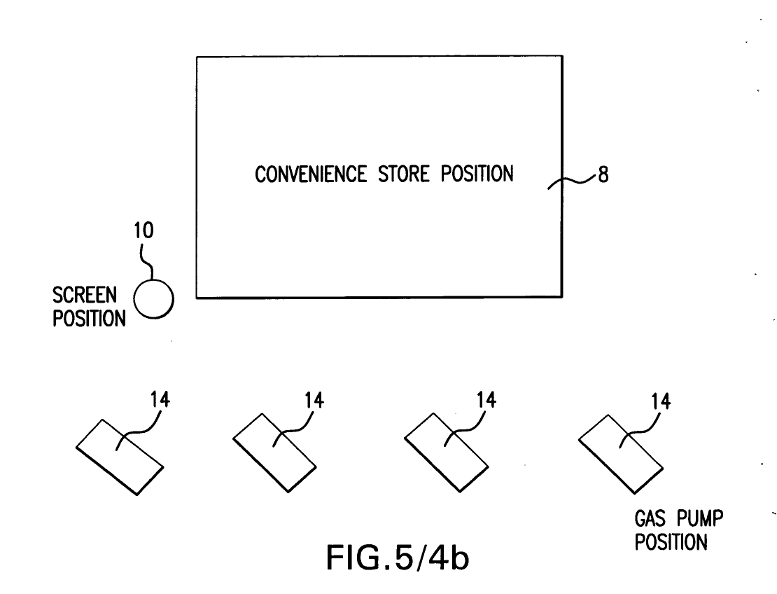

The video screen 10 has three modes of required brightness, being nighttime (about 3000 NITS); normal daytime (about 5000 NITS); and critical daytime (about 7500 NITS), although brightnesses may be used as conditions dictate. Critical daytime is defined as periods during the day when there is direct low angle sunlight onto the face of the screen 10. This is typically early morning for east facing screens; and late afternoon for west facing screens. As this “critical daytime” period is between 4 and 6 hours in duration or between 16% and 25% of the day, it is possible to run the screens at 3 levels of brightness with an average brightness below the quoted 5000 NITS, while having up to 7500 NITS at critical times. The video screen 10 are mounted in a weatherproof metal frame with suitable access for maintenance and are provided with fiberglass branded surround as shown in FIGS. 4 and 5.

The site 4 is equipped with full audio delivery systems both on the forecourt and inside the convenience store. The site system 2 is equipped with automatic volume level control depending upon the level of ambient noise that is being experienced at the time such that the audio level is audible above the ambient noise and the spillage of audio from the site 2 is within legislative and acceptable norms. The system 2 consists of conventional speakers 50 that are used on site 2 at selected positions and in the convenience store 8. The speakers 50 have their base level blocked out to assist in lifting the frequency of played-out audio above the ambient noise level frequency.

A conventional amplifier, such as a RISO/300 amplifier sold by INTERM, monitors the ambient noise level on the site every 10 seconds through the microphone 52 which is mounted at a strategic position of the site depending upon the geometry of the site and the surrounding roads. A gain unit (not shown) then lifts or drops the audio play-out levels in decibels to maintain a “freeboard” of between 7 and 10 decibels above ambient. The microphone 52 is a combined directional and omni-directional unit. It functions as a directional microphone at distances over about 5 meters and as an omni-directional unit at closer distances. This enables it to be pointed at the principal source of off site ambient noise and to pick this up in a directional mode while at the same time picking up general site ambient noise in closer proximity. An example of suitable automatic gain unit is Ambience Compensation AC-330 sold by Air Media Broadcasting in South Africa. The sitting and positioning of the various elements of the system is decisioned such that full coverage of the areas of the site occupied from time to time by customers is achieved.

Typically this is achieved in two different ways for the visual and audio components. The center of gravity of the site in a re-fueling sense is determined. This comes primarily from the arrangement of the pump islands, but is weighted by the most frequently used pumps and pump islands. In addition the center of gravity of the convenience store retail offering 8 is also determined. This is typically at a main entrance doorway into the store and the surrounding fuel company branding.

From a combination of these two criteria the eye line of the customers on the site 4 is determined. The positioning of the visual unit 10 is then decided taking into account limitations imposed by non-infringement of the fuel company branding retail visual identity criteria. The objective is to achieve maximum impact and exposure of the visual unit to all customers who visit the site, who are stationary and captive for the period during which the re-fueling process is underway. This is typically different for fully serviced gasoline stations (where there are attendants who dispense the fuel) and for self-service gasoline stations (where the motorist fuels the vehicle himself).

The audio coverage on the site is designed such that the directional loudspeakers are mounted at or near the pump islands and the stationary motorist is targeted during the re-fueling process. Typically, the speakers 52 are mounted on brackets on the canopy support columns adjacent to the pumps themselves and give a cone of sound around the vehicle and the customer. This maximizes the impact of the audio component to the customer while limiting the spillage of noise to adjacent areas and off the site itself.

The audio system in the store is delivered by ceiling mounted speakers 54 above the retail isles. The customer who is choosing goods is therefore targeted while there is an area of relative silence at the pay desk. This to minimize the interference with the staff in the store.

The installed system 2 at the sites incorporates auto diagnostics. This covers the operation of the on-site PC, audio, display units and content receipt and play-out. The diagnostic system (not shown) is connected automatically to the Data Control Center by the return path. The return path is by terrestrial line because it does not need to have high capacity for these data transfers.

The error messages are received and transferred to the system call center. This is a 24 hour a day, 7 days a week facility which also receives verbal reports from the remote sites in the event of malfunctions. The call center then activates remediation either by Data Control Center action via the satellite or by physical intervention from the maintenance teams. In addition to the automatic fault notification and remediation process above, the remote sites generate logs of all activity and clip play-outs. This retrieved periodically by interrogation and summarized into manageable levels of information.

In FIG. 1, there is illustrated site 4 in which the video screen 10 is optimally positioned to be viewed by all potential customers at the gasoline pumps, in the vehicles and at other areas of the site. The screen 10 possesses unique video quality and performance capabilities to meet the particular physical conditions existing night and day at a gasoline station.

Referring to FIG. 4, there is illustrated a second modified site 4a employing the visual/audio system 2 of the invention. The site 4a includes a pair of parallel gas pumps 14 arranged along right angles adjacent the site of the convenience store 8. The video screen 10 is positioned between the perpendicular rows of gas pumps at the distance previously described to be capable of being viewed by individuals at either of the perpendicular pumps and at other areas of the site.

Referring to FIG. 5 a third gasoline site 4b is illustrated. In site 4b the gas pumps are angularly arranged with respect to the front of the convenience store 8. In order for the video screen 10 to be optimally viewed, the video display is placed adjacent the corner of the convenience store 8 in front of the angularly arranged gas pumps 14.

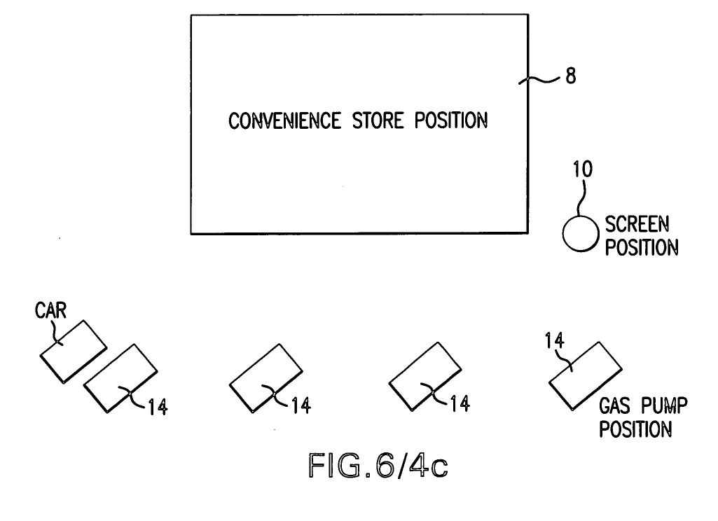

Referring to FIG. 6, there is illustrated a modified site 4c having a plurality of gasoline pumps 14 angled in opposite direction from the gas pumps in the site arrangement shown in FIG. 5. The video screen 10 is optimally situated adjacent to the opposite front corner of the convenience store 8 as seen in FIG. 6.

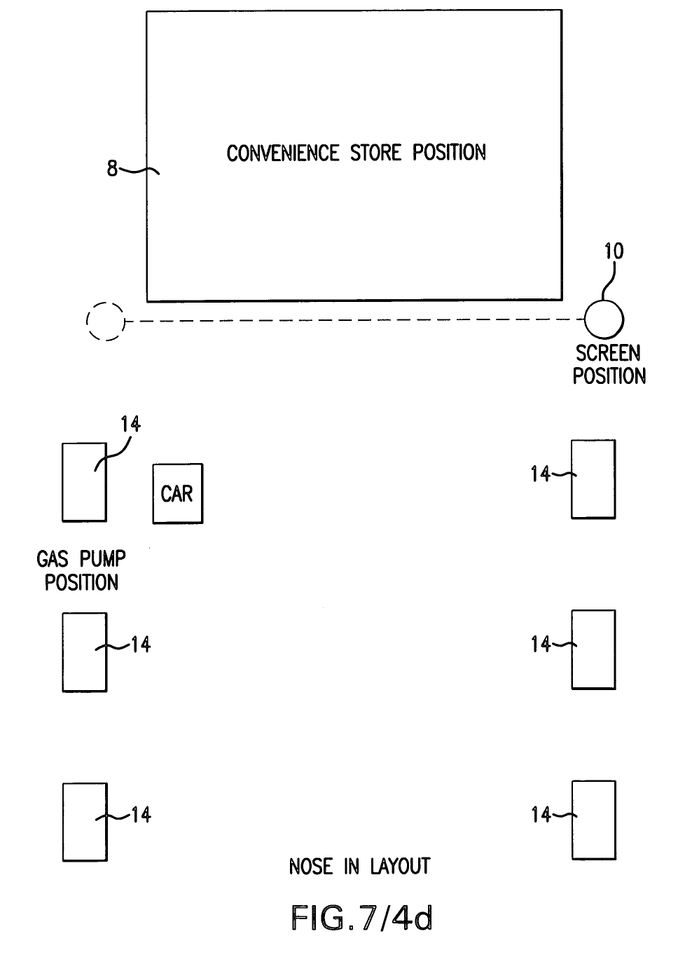

Referring to FIG. 7, a plurality of gasoline pumps 14 is shown on site 4d in which the vehicles face the convenience store 8 in a nose-in configuration. In such an arrangement, the video screen 10 can be positioned anywhere relative to the front of the convenience store 8, generally at selected positions at and between the front corners.

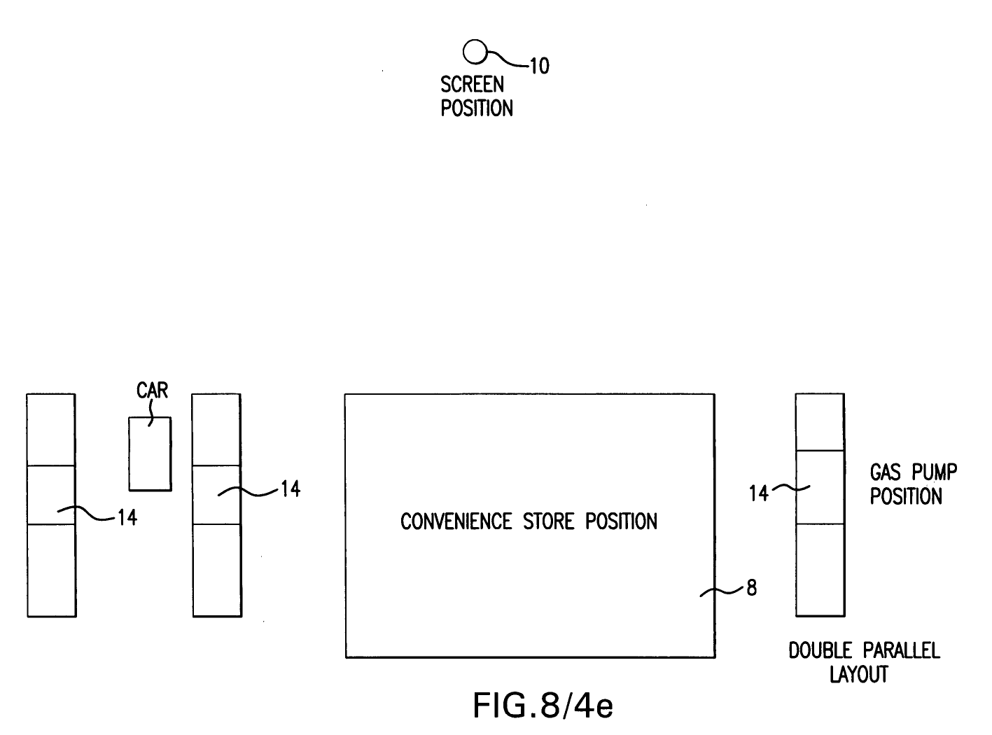

In FIG. 8, the gasoline station site 4e is shown possessing a double parallel layout of gasoline pumps 14 on both sides of the convenience store 8. The video screen 10 is placed in front (or to the opposite side if the vehicles face that direction) to be observed by individuals at both sides of the convenience store 8.

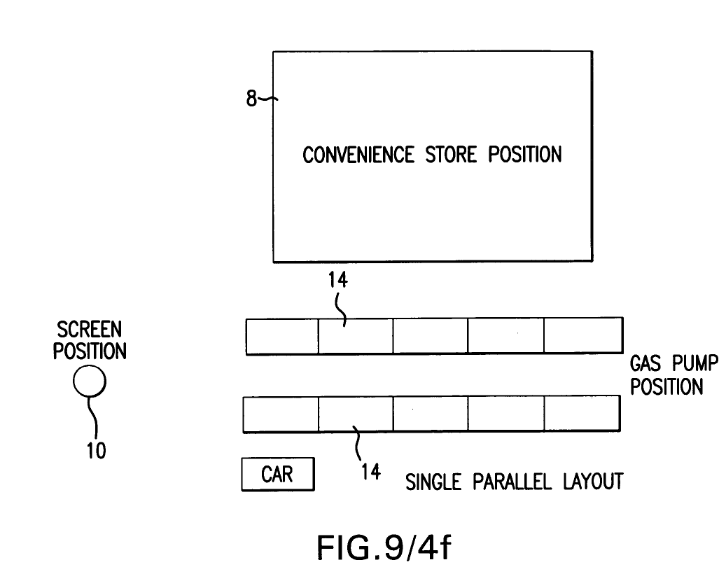

In FIG. 9 there is illustrated a single parallel layout of gasoline pumps 14 at site 4f. The screen 10 is positioned preferably in front of the gasoline pumps 14 as shown.

In the various sites having gasoline pumps laid in range of configurations as shown in the preceding figures, the screen 10 has been placed at a position so that all potential customers can view the video presentation. It is within the scope of the invention to place the video screen at predetermined positions to be viewed by a large number of people at the site when the gasoline pumps are arranged in other geometrical shapes, such as, for example, in semi-circular, circular, elliptical, hexagonal, triangular, square, octagon, diamond shaped, rectangular or non-geometrical arrangements (not shown). The audio speakers are selectively placed at the gasoline pumps for all encountered configurations in a manner to permit the audio to be heard above the ambient noise. The particular positioning of the screens 10 for each arrangement may be adjusted to compensate for particular conditions at the gasoline station site. The screen 10 possesses unique physical characteristics that are designed to meet all conditions existing all day and night at site. The screen position is selected to be viewable within angles of 180 degrees in front of the screen.

What is claimed is:

1. A video/audio display system for providing information and entertainment to one or more individuals positioned in vicinity of fuel dispenser pumps at a site comprising
electronic video display means having a screen for displaying images of the information and entertainment at a predetermined brightness arranged to be seen by each of the one or more individuals at the array of fuel dispenser pumps,
video control means for modifying said predetermined brightness dependent on existing light conditions at the site,
audio delivery means for generating audio outputs of a predetermined level to the one or more individuals in conjunction with the information and entertainment displayed on the screen,
audio control means for adjusting the volume level of said audio outputs in response to the level of ambient noise at the site, and
said screen being positioned to be seen by the one or more individuals being positioned with in at least a horizontal angle of 120° with respect to the images displayed by the screen.

2. The video/audio display system according to claim 1 wherein said video control means provides at least three modes of brightness of said screen.

3. The video/audio display system according to claim 2 wherein said at least three modes of brightness provided by said video control means is dependent are determined for brightness respectively for nighttime conditions light conditions, normal sunlight midday conditions and critical light conditions of a brightness between said nighttime conditions and said normal light conditions.

4. The video/audio display system according to claim 3 wherein said video control means provides in the range of 5,000 nits of brightness on said screen during said normal conditions, 3,000 NITS of brightness on said screen during said nighttime light conditions and 7,500 NITS of light during said critical light conditions.

5. The video/audio display system according to claim 4 wherein said critical light conditions during sunlight conditions at the site have a duration of approximately 16% to 25% of a twenty four hour day.

6. The video/audio display system according to claim 1 wherein said electronic video display means has an LED screen.

7. The video/audio display system according to claim 6 herein said LED screen has a resolution of at least 14,000 pixels.

8. The video/audio display system according to claim 7 further including means electronically to enhance said resolution to at least 85,000 pixels.

9. The video/audio display system according to claim 1 wherein said screen can be viewed a vertical angle of 40%.

10. The video/audio display system according to claim 1 wherein said electronic video display means is connected a satellite dish mounted at the site to provide said images and said audio outputs, said satellite receiving a broadcast quality signal from a satellite, said signal being transmitted to the satellite from a remote generation location.

11. The video/audio display system according to claim 1 wherein said site includes a video monitor for displaying said images to at least some of said one or more individuals and to other individuals than said one or more individuals.

12. The video/audio display system according to claim 1 wherein said audio delivery means includes audio speaker means being mounted at site in audio proximity of said one or more individuals, said speaker means being connected to volume level control means for controlling the level of said audio outputs dependent on ambient noise levels.

13. The video/audio display system according to claim 12 further including means for blocking the base level of said audio outputs to aid in maintaining the frequency of said audio signals above the ambient noise levels.

14. The video/audio display system according to claim 12 wherein said volume level control means includes amplifier means for monitoring the ambient noise levels at the site and maintaining a decibel level of said audio outputs above the ambient noise levels

15. The video/audio display system according to claim 14 wherein said amplifier means maintains said decibel level at a level of approximately between 7 and 10 decibels above the ambient noise levels at the site.

16. The video/audio display system according to claim 14 wherein said amplifier means includes a microphone, said microphone being a directional microphone to detect ambient noise levels at relatively greater distances and an omni-directional microphone to detect ambient noise conditions at a closer proximity than said greater distances.

17. A video/audio display system for providing information and entertainment to one or more individuals positioned in vicinity of fuel dispenser pumps at a site comprising
electronic video display means having a screen for displaying images of the information and entertainment at a predetermined brightness arranged to be seen by each of the one or more individuals at the array of fuel dispenser pumps,
video-control means for modifying said predetermined brightness dependent on existing light conditions at the site,
audio delivery means for generating audio outputs of a predetermined level to the one or more individuals in conjunction with the information and entertainment displayed on the screen, and
audio control means for adjusting the volume level of said audio outputs in response to the level of ambient noise at the site.

18. A method of providing visual and audio information and entertainment to a plurality of customers situated at petroleum dispensing pumps at a petroleum outlet site comprising the steps of
providing an array of petroleum dispensing pumps at the outlet site to allow customers to obtain petroleum for their respective vehicles,
mounting a video screen displaying the visual images of the information and entertainment at a position optimally situated to be viewed by the customers and other individuals at said array of petroleum dispensing pumps within a horizontal viewing angle of at least 120° with respect to the front of the video screen, and
situating audio speakers adjacent to the petroleum dispensing pumps to provide audio portion of the information and entertainment being displayed on the screen at audio levels above ambient noise levels.

19. The method of providing visual and audio advertisements and information according to claim 18 further comprising the step of adjusting the brightness of said video screen in accordance with light conditions at said outlet site.

20. The method of providing visual and audio advertisements and information according to claim 19 further comprising the step of maintaining said audio output at least seven decibels above ambient noise levels.

21. The method of providing visual and audio advertisements and information according to claim 18 wherein said array of pumps include at least two rows of pumps situated at right angles to each other, said video screen being positioned between said perpendicularly arranged pumps.

22. The method of providing visual and audio advertisements and information according to claim 18 wherein said array of pumps are angularly arranged along generally parallel axes in front of a convenience store, said video screen being positioned adjacent the convenience store on a side at which said parallel axes generally extend.

23. The method of providing visual and audio advertisements and information according to claim 18 wherein said array of pumps are arranged along generally parallel axes on both sides of a convenience store, said video screen being positioned in front of said rows to be viewed.
